(19) United States
(12) Patent Application Publication
(10) Pub. No.: US 2019/0320422 A1
(43) Pub. Date: Oct. 17, 2019

(54) Time Domain Resource Allocation For Compact Downlink Control Information In Mobile Communications

(71) Applicant: MediaTek Singapore Pte. Ltd., Singapore (SG)

(72) Inventors: Mohammed S Aleabe Al-Imari, Cambridge (GB); Raghavendra Ramakrishna, Cambridge (GB)

(21) Appl. No.: 16/383,549

(22) Filed: Apr. 12, 2019

Related U.S. Application Data
(60) Provisional application No. 62/656,545, filed on Apr. 12, 2018.

(51) Int. Cl. H04W 72/04; H04W 72/12

(52) U.S. Cl. CPC H04W 72/042; H04W 72/12

(57) ABSTRACT

Various solutions for time domain resource allocation for compact downlink control information (DCI) design and operations with respect to user equipment and network apparatus in mobile communications are described. An apparatus may receive a compact DCI on a physical downlink control channel (PDCCH). The apparatus may extract an implicit scheduling parameter from the compact DCI. The apparatus may determine a time domain resource allocation according to the implicit scheduling parameter. The apparatus may perform a downlink or uplink transmission according to the time domain resource allocation.

### CROSS REFERENCE TO RELATED PATENT APPLICATION(S)

The present disclosure is part of a non-provisional application claiming the priority benefit of U.S. patent application Ser. No. 62/656,545, filed on 12 Apr. 2018, the content of which is incorporated by reference in its entirety.

### TECHNICAL FIELD

The present disclosure is generally related to mobile communications and, more particularly, to time domain resource allocation for compact downlink control information (DCI) design and operations with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

Some of the fields of the normal DCI are not applicable or does not make sense for the high latency sensitive transmissions. Reliability of the DCI depends on the size. The smaller the size of DCI is, the better the reliability may be given that the transmission resources are same due to the lower coding gain. Using normal DCI for the same reliability may need to increase the aggregation level, which has the drawback of blocking probability. Besides, smaller bandwidth parts may not be able to accommodate higher aggregation levels. Accordingly, compact DCI design is needed by the fact that the normal DCI size is large and inefficient for the URLLC control transmissions.

It can be expected to have a diverse range of URLLC services in the future, each targeting a different use case. Accordingly, how to fulfil strict reliability requirements may become a new issue in the newly developed communication system. It is needed to provide proper compact DCI design and operations to reduce DCI size and improve reliability for control signal transmissions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to time domain resource allocation for compact DCI design and operations with respect to user equipment and network apparatus in mobile communications.

In one aspect, a method may involve an apparatus receiving a compact DCI on a physical downlink control channel (PDCCH). The method may also involve the apparatus extracting an implicit scheduling parameter from the compact DCI. The method may further involve the apparatus determining a time domain resource allocation according to the implicit scheduling parameter. The method may further involve the apparatus performing a downlink or uplink transmission according to the time domain resource allocation.

In one aspect, an apparatus may comprise a transceiver capable of wirelessly communicating with a network node of a wireless network. The apparatus may also comprise a processor communicatively coupled to the transceiver. The processor may be capable of receiving, via the transceiver, a compact DCI on a PDCCH. The processor may also be capable of extracting an implicit scheduling parameter from the compact DCI. The processor may further be capable of determining a time domain resource allocation according to the implicit scheduling parameter. The processor may further be capable of performing, via the transceiver, a downlink or uplink transmission according to the time domain resource allocation.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting example scenarios under schemes in accordance with implementations of the present disclosure.

FIG. 3 is a diagram depicting an example scenario under schemes in accordance with implementations of the present disclosure.

FIG. 4 is a diagram depicting example scenarios under schemes in accordance with implementations of the present disclosure.

FIG. 5 is a diagram depicting an example scenario under schemes in accordance with implementations of the present disclosure.

FIG. 6 is a diagram depicting example scenarios under schemes in accordance with implementations of the present disclosure.

FIG. 7 is a diagram depicting an example scenario under schemes in accordance with implementations of the present disclosure.

FIG. 8 is a diagram depicting example scenarios under schemes in accordance with implementations of the present disclosure.

FIG. 9 is a diagram depicting an example scenario under schemes in accordance with implementations of the present disclosure.

FIG. 10 is a diagram depicting example scenarios under schemes in accordance with implementations of the present disclosure.

FIG. 11 is a block diagram of an example communication apparatus and an example network apparatus in accordance with an implementation of the present disclosure.

FIG. 12 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to time domain resource allocation for compact DCI with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, URLLC is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

Some of the fields of the normal DCI are not applicable or does not make sense for the high latency sensitive transmissions. Reliability of the DCI depends on the size. The smaller the size of DCI is, the better the reliability may be given that the transmission resources are same due to the lower coding gain. Using normal DCI for the same reliability may need to increase the aggregation level, which has the drawback of blocking probability. Besides, smaller bandwidth parts may not be able to accommodate higher aggregation levels. Accordingly, compact DCI design is needed by the fact that the normal DCI size is large and inefficient for the URLLC control transmissions.

The UE shall determine the resource block assignment in time domain using the resource assignment field in the detected PDCCH DCI. The time domain resource assignment field of the DCI provides scheduling parameters including the slot offset (e.g., K2), the start and length indicator (e.g., SLIV), and the physical uplink shared channel (PUSCH) mapping type to be applied in the PUSCH transmission. In URLLC, it is expected that the network will schedule the UE with the earliest available resources. Thus, it is not expected that the network uses large values of the scheduling parameters.

In view of the above, the present disclosure proposes a number of schemes pertaining to time domain resource allocation for compact DCI with respect to the UE and the network apparatus. According to the schemes of the present disclosure, compact DCI format for URLLC may be defined and used for URLLC services. The bit-fields of compact DCI may be carefully designed to reduce the size of the DCI. Specifically, the number of time domain resource allocation bits in the DCI may be reduced by using implicit indication for the scheduling parameters. Compact DCI design for URLLC may improve the reliability of control channel. Such design may also reduce the need for higher aggregation level to meet the reliability thereby reducing the blocking probability.

To reduce the number of bits in the compact DCI, some of the scheduling parameters may be implicitly indicated to the UE. The possible values for the implicitly indicated scheduling parameters may be restricted to a small set of values. The UE may be configured to receive the compact DCI on the PDCCH. The UE may extract the implicit scheduling parameter from the compact DCI. The UE may be configured to determine the time domain resource allocation according to the implicit scheduling parameter. The UE may perform a downlink or uplink transmission according to the time domain resource allocation. The implicit scheduling parameter may comprise at least one of a slot offset K0, a slot offset K1, a slot offset K2, a mapping type, and a table.

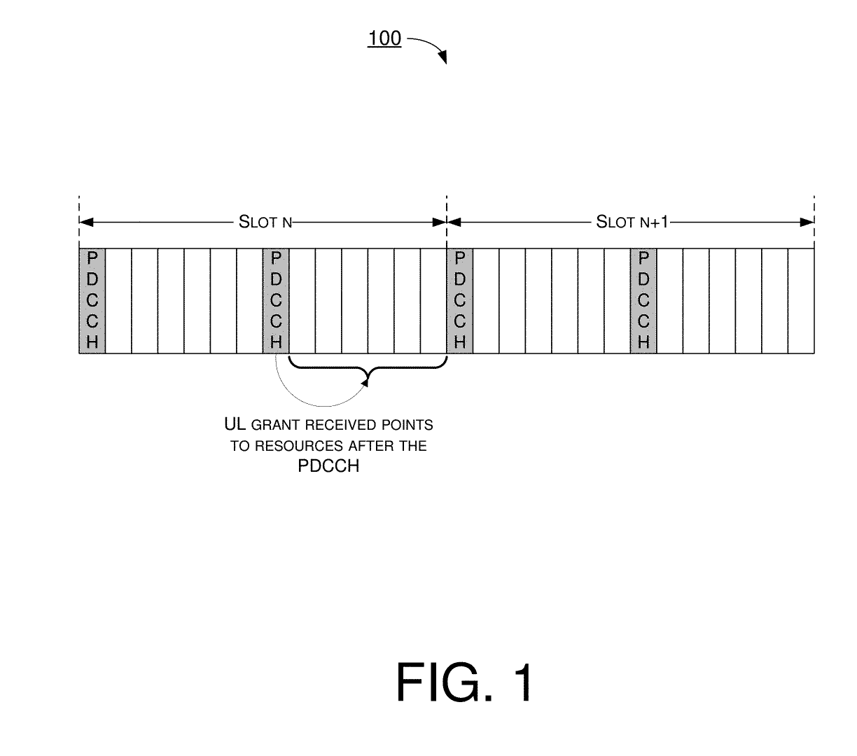

For example, to reduce the number of bits required in the time domain resource assignment field of the DCI, the value of the slot offset K2 may be implicitly indicated to the UE. FIG. 1 illustrates an example scenario 100 under schemes in accordance with implementations of the present disclosure. Scenario 100 involves a UE and a network apparatus, which may be a part of a wireless communication network (e.g., an LTE network, an LTE-Advanced network, an LTE-Advanced Pro network, a 5G network, an NR network, an IoT network or an NB-IoT network). After receiving the uplink (UL) grant on the PDCCH, the UE may be configured to determine the value of the scheduling parameter (e.g., the slot offset K2). When the implicit scheduling parameter indicates a first value (e.g., K2=0), the UE may be configured to determine that the time domain resource allocation starts after the PDCCH. The UE may be able to perform the uplink transmission on the allocated time domain resources.

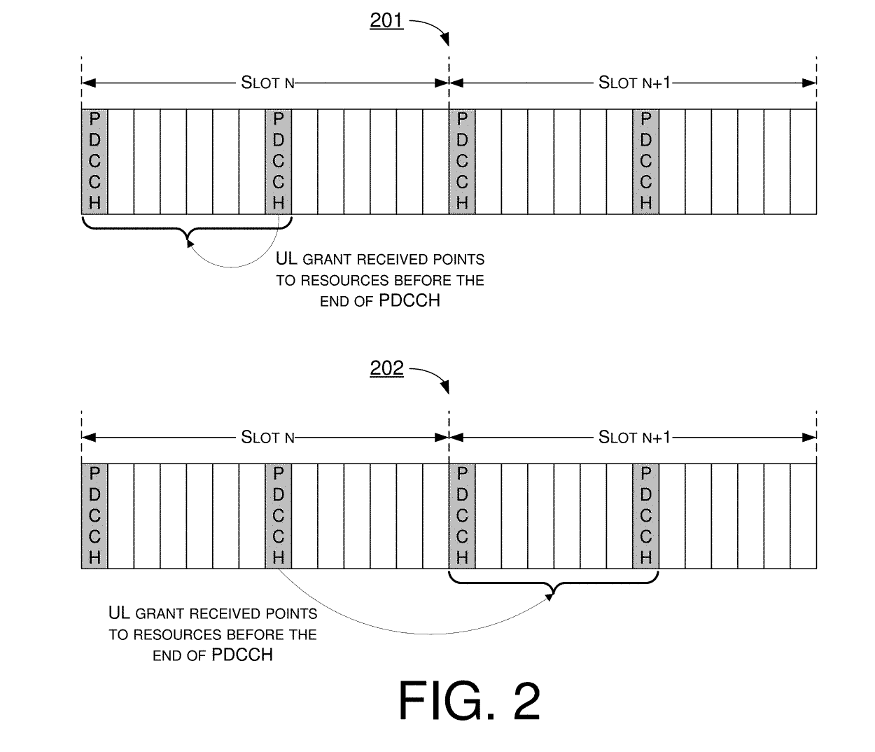

FIG. 2 illustrates example scenarios 201 and 202 under schemes in accordance with implementations of the present disclosure. Scenarios 201 and 202 involve a UE and a network apparatus, which may be a part of a wireless communication network. In scenario 201, after receiving the UL grant on the PDCCH, the UE may be configured to determine the value of the scheduling parameter (e.g., the slot offset K2). When the implicit scheduling parameter indicates a second value (e.g., K2=1), the UE may be configured to determine that the time domain resource allocation starts before the end of the PDCCH in the same slot (e.g., slot n). The UE may be able to perform the uplink transmission on the allocated time domain resources. In scenario 202, the implicit scheduling parameter may refer to the time domain resources in another slot. For example, when the implicit scheduling parameter indicates a second value (e.g., K2=1), the UE may be configured to determine that the time domain resource allocation starts before the end of the PDCCH in the next slot (e.g., slot n+1). The UE may be able to perform the uplink transmission on the allocated time domain resources.

Accordingly, the network may be able to use only one bit (e.g., 0 or 1) for the implicit scheduling parameter to indicate the time domain resource allocation to the UE. The UE may be able to determine the time domain resource allocation according to the one bit indication. Thus, the number of bits for the time domain resource assignment field in the DCI may be significantly reduced for the compact DCI design.

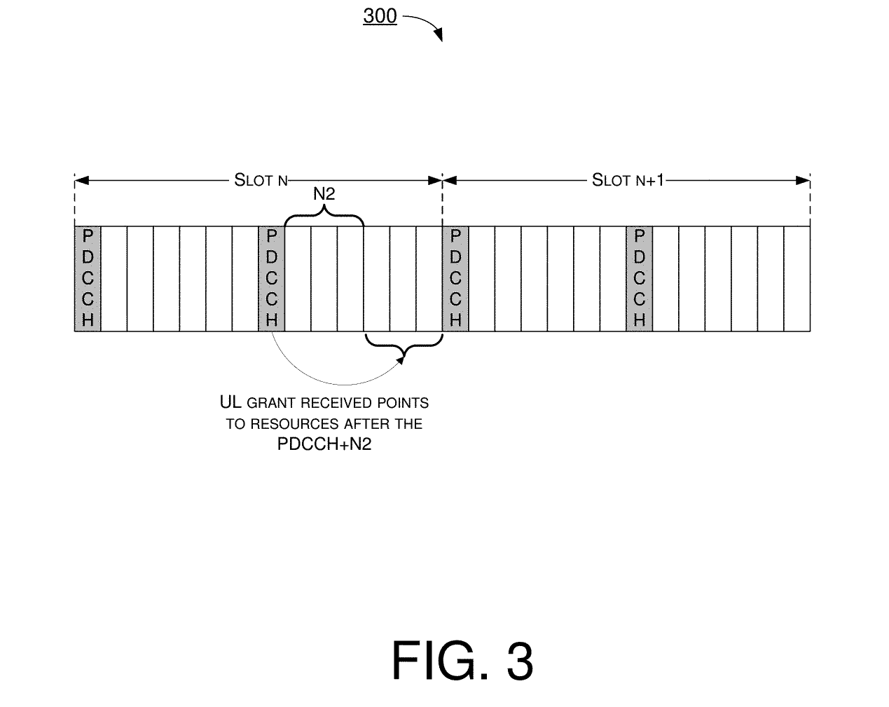

Alternatively, the network may further take the UE processing time (e.g., PUSCH processing capability N2) into account. The network may use the implicit scheduling parameter to indicate UE the time domain resource allocation with the consideration of the UE processing time. FIG. 3 illustrates an example scenario 300 under schemes in accordance with implementations of the present disclosure. Scenario 300 involves a UE and a network apparatus, which may be a part of a wireless communication network. After receiving the UL grant on the PDCCH, the UE may be configured to determine the value of the scheduling parameter (e.g., the slot offset K2). When the implicit scheduling parameter indicates a first value (e.g., K2=0), the UE may be configured to determine that the time domain resource allocation starts after the PDCCH combined with the UE processing time (e.g., N2). The UE may be able to perform the uplink transmission on the allocated time domain resources.

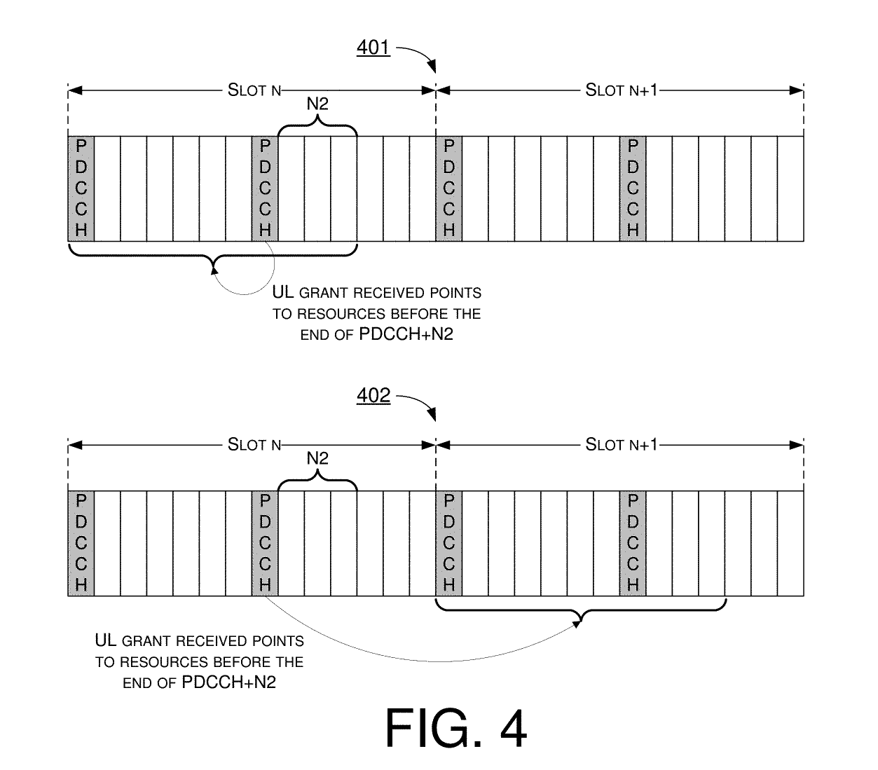

FIG. 4 illustrates example scenarios 401 and 402 under schemes in accordance with implementations of the present disclosure. Scenarios 401 and 402 involve a UE and a network apparatus, which may be a part of a wireless communication network. In scenario 401, after receiving the UL grant on the PDCCH, the UE may be configured to determine the value of the scheduling parameter (e.g., the slot offset K2). When the implicit scheduling parameter indicates a second value (e.g., K2=1), the UE may be configured to determine that the time domain resource allocation starts before the end of the PDCCH combined with the UE processing time (e.g., N2) in the same slot (e.g., slot n). The UE may be able to perform the uplink transmission on the allocated time domain resources. In scenario 402, the implicit scheduling parameter may refer to the time domain resources in another slot. For example, when the implicit scheduling parameter indicates a second value (e.g., K2=1), the UE may be configured to determine that the time domain resource allocation starts before the end of the PDCCH combined with the UE processing time (e.g., N2) in the next slot (e.g., slot n+1). The UE may be able to perform the uplink transmission on the allocated time domain resources.

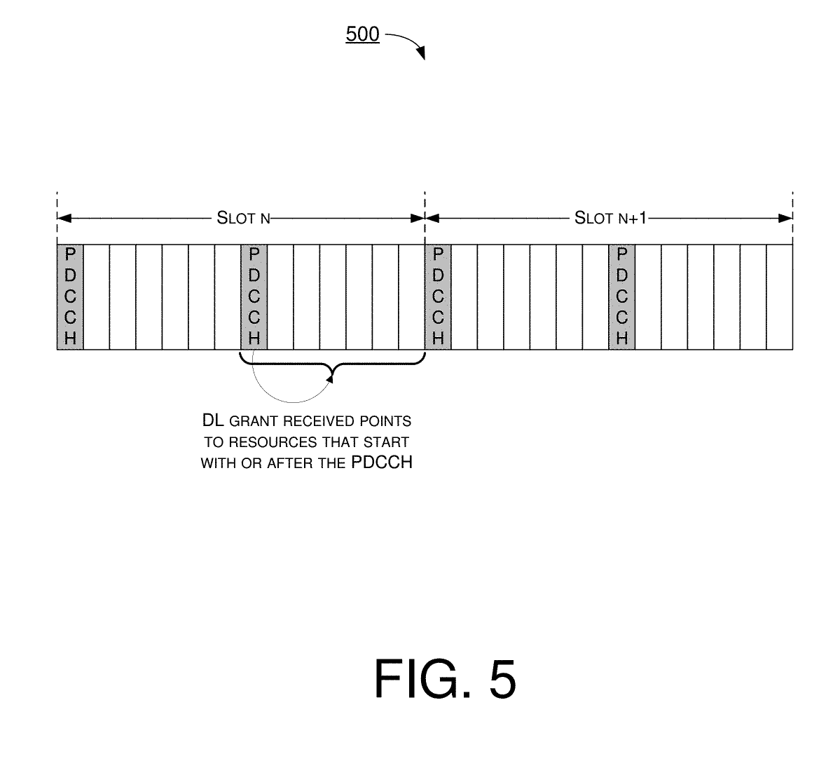

In another example, to reduce the number of bits required in the time domain resource assignment field of the DCI, the value of the slot offset K0 may be implicitly indicated to the UE. The slot offset K0 may be used for the physical downlink shared channel (PDSCH) allocation. FIG. 5 illustrates an example scenario 500 under schemes in accordance with implementations of the present disclosure. Scenario 500 involves a UE and a network apparatus, which may be a part of a wireless communication network. After receiving the downlink (DL) grant on the PDCCH, the UE may be configured to determine the value of the scheduling parameter (e.g., the slot offset K0). When the implicit scheduling parameter indicates a first value (e.g., K0=0), the UE may be configured to determine that the time domain resource allocation starts with or after the PDCCH. The UE may be able to perform the downlink transmission on the allocated time domain resources.

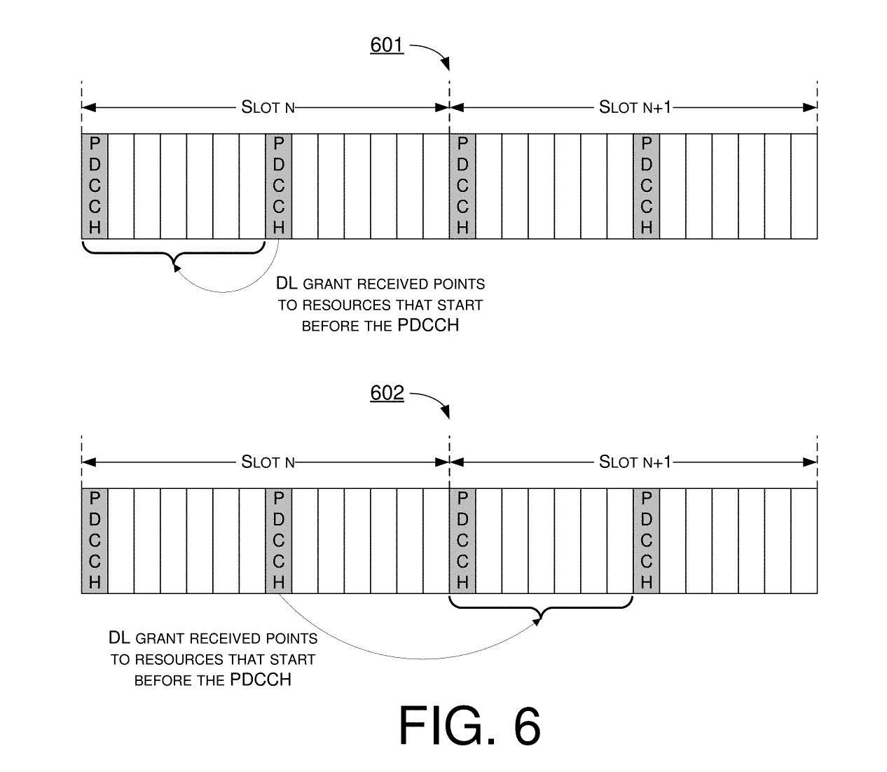

FIG. 6 illustrates example scenarios 601 and 602 under schemes in accordance with implementations of the present disclosure. Scenarios 601 and 602 involve a UE and a network apparatus, which may be a part of a wireless communication network. In scenario 601, after receiving the DL grant on the PDCCH, the UE may be configured to determine the value of the scheduling parameter (e.g., the slot offset K0). When the implicit scheduling parameter indicates a second value (e.g., K0=1), the UE may be configured to determine that the time domain resource allocation starts before the PDCCH in the same slot (e.g., slot n). The UE may be able to perform the downlink transmission on the allocated time domain resources. In scenario 602, the implicit scheduling parameter may refer to the time domain resources in another slot. For example, when the implicit scheduling parameter indicates a second value (e.g., K0=1), the UE may be configured to determine that the time domain resource allocation starts before the PDCCH in the next slot (e.g., slot n+1). The UE may be able to perform the downlink transmission on the allocated time domain resources.

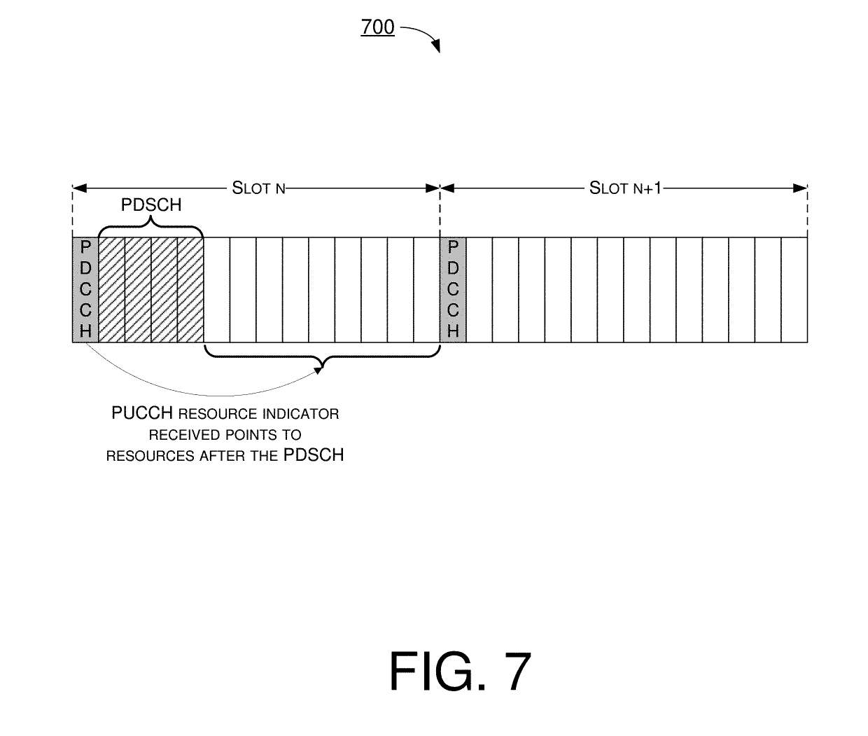

In another example, to reduce the number of bits required in the time domain resource assignment field of the DCI, the value of the slot offset K1 may be implicitly indicated to the UE. The slot offset K1 may be used for the hybrid automatic repeat request (HARQ) feedback indication (e.g., PDSCH-to-HARQ feedback timing indication). FIG. 7 illustrates an example scenario 700 under schemes in accordance with implementations of the present disclosure. Scenario 700 involves a UE and a network apparatus, which may be a part of a wireless communication network. The UE may receive the PDCCH comprising the downlink assignment (e.g., PDSCH) and the physical uplink control channel (PUCCH) resource indicator. After receiving the PUCCH resource indicator, the UE may be configured to determine the value of the scheduling parameter (e.g., the slot offset K1). When the implicit scheduling parameter indicates a first value (e.g., K1=0), the UE may be configured to determine that the time domain resource allocation starts after the PDSCH. The UE may be able to perform the uplink transmission on the allocated time domain resources.

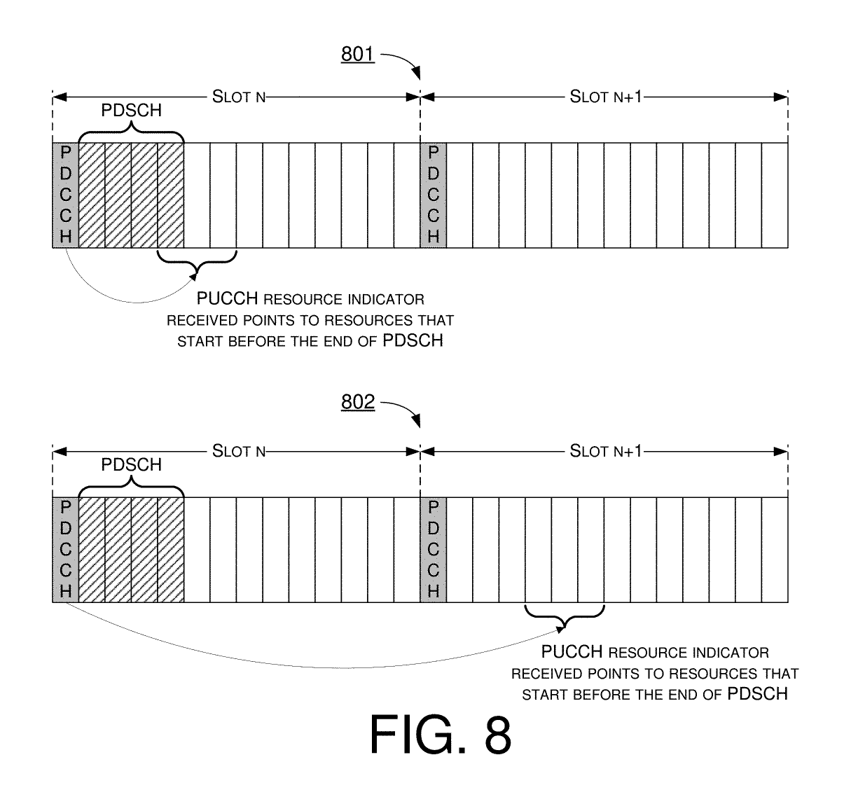

FIG. 8 illustrates example scenarios 801 and 802 under schemes in accordance with implementations of the present disclosure. Scenarios 801 and 802 involve a UE and a network apparatus, which may be a part of a wireless communication network. In scenario 801, the UE may receive the PDCCH comprising the downlink assignment (e.g., PDSCH) and the PUCCH resource indicator. After receiving the PUCCH resource indicator, the UE may be configured to determine the value of the scheduling parameter (e.g., the slot offset K1). When the implicit scheduling parameter indicates a second value (e.g., K1=1), the UE may be configured to determine that the time domain resource allocation starts before the end of the PDSCH in the same slot (e.g., slot n). The UE may be able to perform the uplink transmission on the allocated time domain resources. In scenario 802, the implicit scheduling parameter may refer to the time domain resources in another slot. For example, when the implicit scheduling parameter indicates a second value (e.g., K1=1), the UE may be configured to determine that the time domain resource allocation starts before the end of the PDSCH in the next slot (e.g., slot n+1). The UE may be able to perform the uplink transmission on the allocated time domain resources.

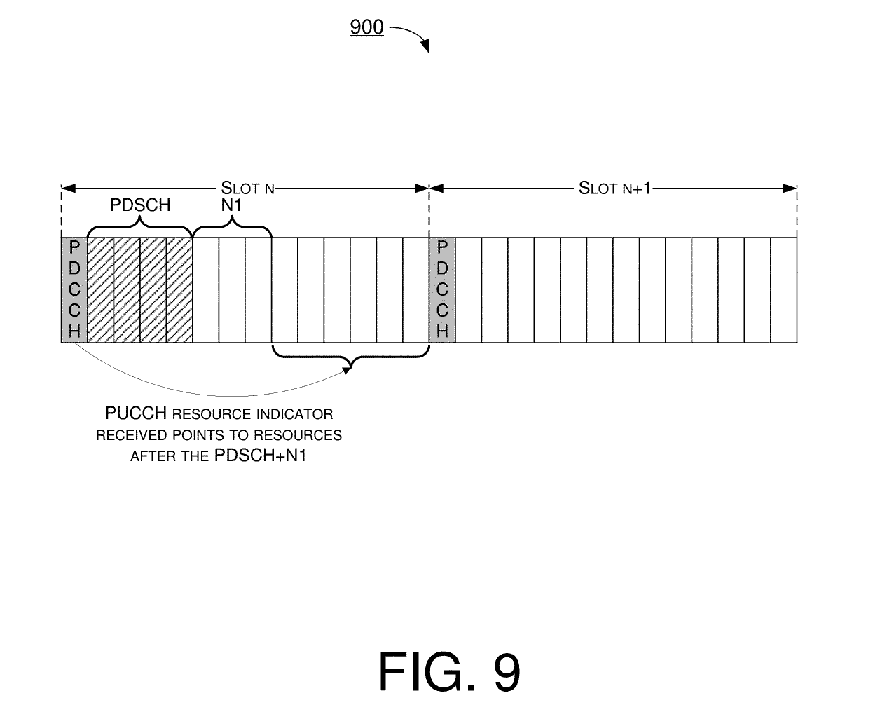

Alternatively, the network may further take the UE processing time (e.g., PDSCH processing capability N1) into account. The network may use the implicit scheduling parameter to indicate UE the time domain resource allocation with the consideration of the UE processing time. FIG. 9 illustrates an example scenario 900 under schemes in accordance with implementations of the present disclosure. Scenario 900 involves a UE and a network apparatus, which may be a part of a wireless communication network. The UE may receive the PDCCH comprising the downlink assignment (e.g., PDSCH) and the PUCCH resource indicator. After receiving the PUCCH resource indicator, the UE may be configured to determine the value of the scheduling parameter (e.g., the slot offset K1). When the implicit scheduling parameter indicates a first value (e.g., K1=0), the UE may be configured to determine that the time domain resource allocation starts after the PDSCH combined with a processing time (e.g., N1). The UE may be able to perform the uplink transmission on the allocated time domain resources.

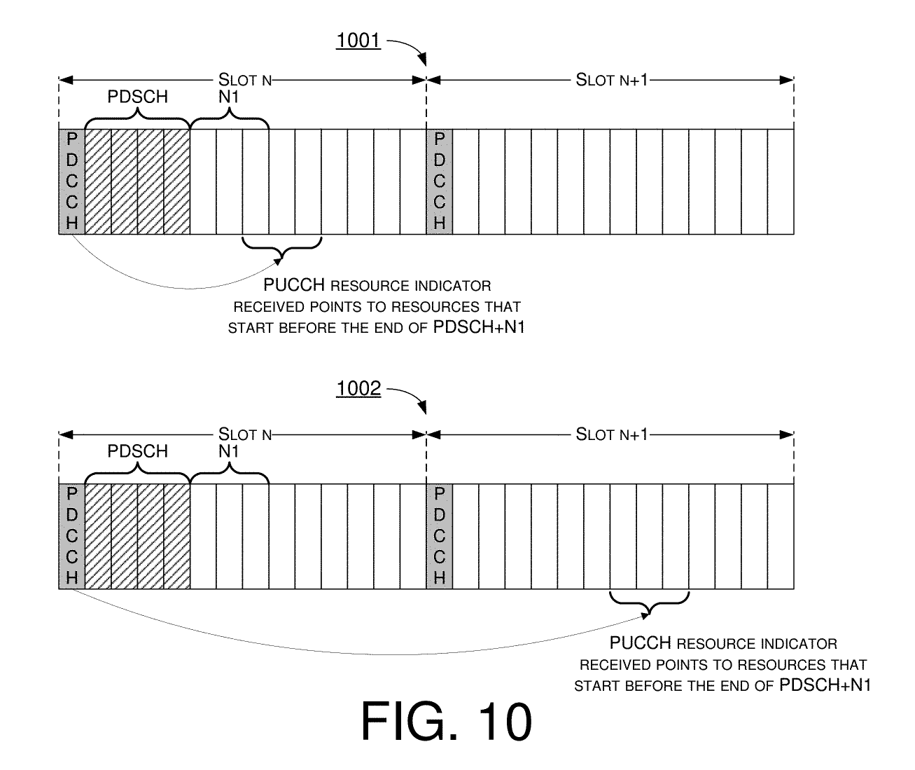

FIG. 10 illustrates example scenarios 1001 and 1002 under schemes in accordance with implementations of the present disclosure. Scenarios 1001 and 1002 involve a UE and a network apparatus, which may be a part of a wireless communication network. In scenario 1001, the UE may receive the PDCCH comprising the downlink assignment (e.g., PDSCH) and the PUCCH resource indicator. After receiving the PUCCH resource indicator, the UE may be configured to determine the value of the scheduling parameter (e.g., the slot offset K1). When the implicit scheduling parameter indicates a second value (e.g., K1=1), the UE may be configured to determine that the time domain resource allocation starts before the end of the PDSCH combined with a processing time (e.g., N1) in the same slot (e.g., slot n). The UE may be able to perform the uplink transmission on the allocated time domain resources. In scenario 1002, the implicit scheduling parameter may refer to the time domain resources in another slot. For example, when the implicit scheduling parameter indicates a second value (e.g., K1=1), the UE may be configured to determine that the time domain resource allocation starts before the end of the PDSCH combined with a processing time (e.g., N1) in the next slot (e.g., slot n+1). The UE may be able to perform the uplink transmission on the allocated time domain resources.

In another example, to reduce the number of bits required in the time domain resource assignment field of the DCI, the PUSCH mapping type may be implicitly indicated to the UE. The UE may be configured to determine the PUSCH mapping type according to the implicit scheduling parameter. The implicit scheduling parameter may comprise the symbol index indicated for the PUSCH. In an event that the time domain resource allocation for the PUSCH indicates a first symbol index (e.g., symbol index 0) in the slot (e.g., first symbol in the slot) as the starting symbol, the UE may be configured to determinehat the PUSCH mapping type is a first type (e.g., type A). In an event that the time domain resource allocation for the PUSCH indicates a second symbol index (e.g., symbol index 1-13) in the slot (e.g., the symbols in the slot apart from the first symbol) as the starting symbol, the UE may be configured to determinehat the PUSCH mapping type is a second type (e.g., type B). The UE may be able to perform the uplink transmission according to the determined PUSCH mapping type.

Similarly, the implicit scheduling parameter may comprise the symbol index indicated for the PDSCH. In an event that the time domain resource allocation for the PDSCH indicates a first symbol index in the slot (e.g., one of the first X symbols I in the slot) as the starting symbol, the UE may be configured to determinehat the PUSCH mapping type is a first type (e.g., type A). In an event that the time domain resource allocation for the PUSCH indicates a second symbol index in the slot (e.g., one of the last 14-X symbols in the slot) as the starting symbol, the UE may be configured to determinehat the PUSCH mapping type is a second type (e.g., type B). For example and without limitation, the X may be equal to 4. The UE may be able to perform the uplink transmission according to the determined PUSCH mapping type.

In some implementations, the network may configure the UE with a table for the time domain resource allocation for PUSCH and/or PDSCH. The UE may be configured to determine a starting time of the time domain resource allocation according to the table. The table may be partially or completely different from the table separate used for the other scheduling DCI formats. The reference point for starting time of the resource allocation for PUSCH and/or PDSCH for type B may be different from one for other scheduling DCI formats. For example, the last symbol of the scheduling PDCCH may be used as the reference point for starting time of resource allocation for PUSCH and/or PDSCH for type B.

### Illustrative Implementations

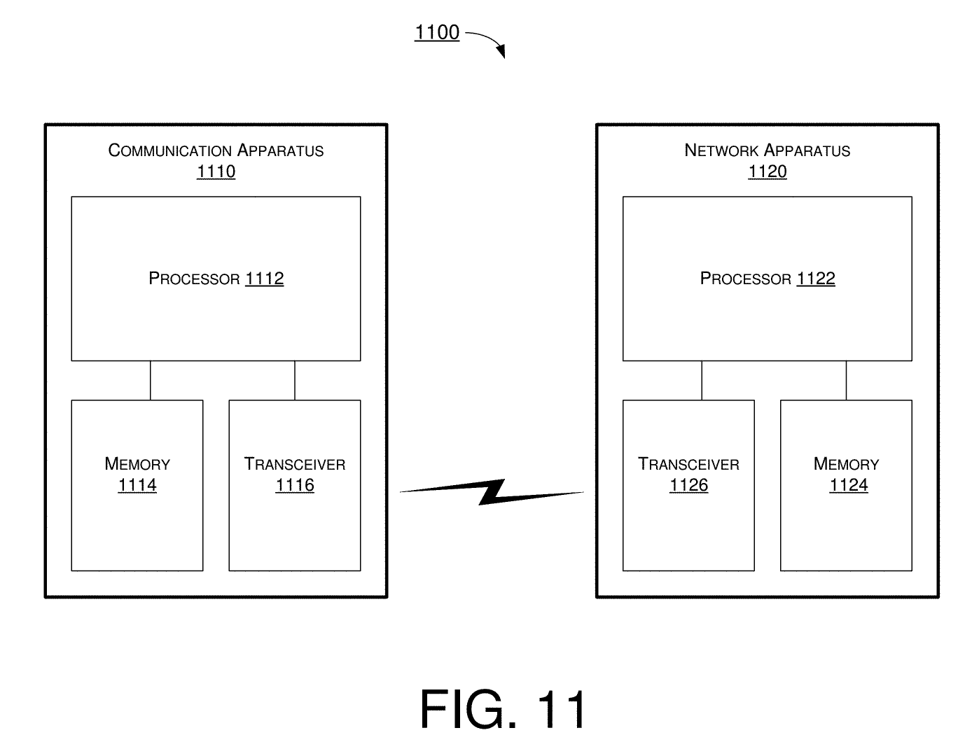

FIG. 11 illustrates an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to time domain resource allocation for compact DCI design and operations with respect to user equipment and network apparatus in wireless communications, including scenarios described above as well as process 1200 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, a digital camera, or a computing equipment such as a tablet computer, a laptop computer or a notebook computer. Communication apparatus 1110 may also be a part of a machine type apparatus, which may be an IoT or NB-IoT apparatus such as an immobile or a stationary apparatus, a home apparatus, a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of an electronic apparatus, which may be a network node such as a base station, a small cell, a router or a gateway. For instance, network apparatus 1120 may be implemented in an eNodeB in an LTE, LTE-Advanced or LTE-Advanced Pro network or in a gNB in a 5G, NR, IoT or NB-IoT network. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more RISC or CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including power consumption reduction in a device (e.g., as represented by communication apparatus 1110) and a network (e.g., as represented by network apparatus 1120) in accordance with various implementations of the present disclosure.

In some implementations, communication apparatus 1110 may also include a transceiver 1116 coupled to processor 1112 and capable of wirelessly transmitting and receiving data. In some implementations, communication apparatus 1110 may further include a memory 1114 coupled to processor 1112 and capable of being accessed by processor 1112 and storing data therein. In some implementations, network apparatus 1120 may also include a transceiver 1126 coupled to processor 1122 and capable of wirelessly transmitting and receiving data. In some implementations, network apparatus 1120 may further include a memory 1124 coupled to processor 1122 and capable of being accessed by processor 622 and storing data therein. Accordingly, communication apparatus 1110 and network apparatus 1120 may wirelessly communicate with each other via transceiver 1116 and transceiver 1126, respectively. To aid better understanding, the following description of the operations, functionalities and capabilities of each of communication apparatus 1110 and network apparatus 1120 is provided in the context of a mobile communication environment in which communication apparatus 1110 is implemented in or as a communication apparatus or a UE and network apparatus 1120 is implemented in or as a network node of a communication network.

In some implementations, processor 1112 may be configured to receive, via transceiver 1116, the compact DCI on the PDCCH. Processor 1112 may extract the implicit scheduling parameter from the compact DCI. Processor 1112 may be configured to determine the time domain resource allocation according to the implicit scheduling parameter. Processor 1112 may perform, via transceiver 1116, a downlink or uplink transmission according to the time domain resource allocation. The implicit scheduling parameter may comprise at least one of a slot offset K0, a slot offset K1, a slot offset K2, a mapping type, and a table.

In some implementations, after receiving the UL grant on the PDCCH, processor 1112 may be configured to determine the value of the scheduling parameter (e.g., the slot offset K2). When the implicit scheduling parameter indicates a first value (e.g., K2=0), the UE may be configured to determine that the time domain resource allocation starts after the PDCCH. Processor 1112 may be able to perform the uplink transmission on the allocated time domain resources.

In some implementations, after receiving the UL grant on the PDCCH, processor 1112 may be configured to determine the value of the scheduling parameter (e.g., the slot offset K2). When the implicit scheduling parameter indicates a second value (e.g., K2=1), processor 1112 may be configured to determine that the time domain resource allocation starts before the end of the PDCCH in the same slot (e.g., slot n) or in the next slot (e.g., slot n+1). Processor 1112 may be able to perform the uplink transmission on the allocated time domain resources.

In some implementations, after receiving the UL grant on the PDCCH, processor 1112 may be configured to determine the value of the scheduling parameter (e.g., the slot offset K2). When the implicit scheduling parameter indicates a first value (e.g., K2=0), processor 1112 may be configured to determine that the time domain resource allocation starts after the PDCCH combined with a processing time (e.g., N2). Processor 1112 may be able to perform the uplink transmission on the allocated time domain resources.

In some implementations, after receiving the UL grant on the PDCCH, processor 1112 may be configured to determine the value of the scheduling parameter (e.g., the slot offset K2). When the implicit scheduling parameter indicates a second value (e.g., K2=1), processor 1112 may be configured to determine that the time domain resource allocation starts before the end of the PDCCH combined with a processing time (e.g., N2) in the same slot (e.g., slot n) or in the next slot (e.g., slot n+1). Processor 1112 may be able to perform the uplink transmission on the allocated time domain resources.

In some implementations, after receiving the DL grant on the PDCCH, processor 1112 may be configured to determine the value of the scheduling parameter (e.g., the slot offset K0). When the implicit scheduling parameter indicates a first value (e.g., K0=0), processor 1112 may be configured to determine that the time domain resource allocation starts with or after the PDCCH. Processor 1112 may be able to perform the downlink transmission on the allocated time domain resources.

In some implementations, after receiving the DL grant on the PDCCH, processor 1112 may be configured to determine the value of the scheduling parameter (e.g., the slot offset K0). When the implicit scheduling parameter indicates a second value (e.g., K0=1), processor 1112 may be configured to determine that the time domain resource allocation starts before the PDCCH in the same slot (e.g., slot n) or in the next slot (e.g., slot n+1). Processor 1112 may be able to perform the downlink transmission on the allocated time domain resources.

In some implementations, processor 1112 may receive, via transceiver 1116, the PDCCH comprising the downlink assignment (e.g., PDCCH) and the PUCCH resource indicator. After receiving the PUCCH resource indicator, processor 1112 may be configured to determine the value of the scheduling parameter (e.g., the slot offset K1). When the implicit scheduling parameter indicates a first value (e.g., K1=0), processor 1112 may be configured to determine that the time domain resource allocation starts after the PDSCH. Processor 1112 may be able to perform the uplink transmission on the allocated time domain resources.

In some implementations, processor 1112 may receive, via transceiver 1116, the PDCCH comprising the downlink assignment (e.g., PDSCH) and the PUCCH resource indicator. After receiving the PUCCH resource indicator, processor 1112 may be configured to determine the value of the scheduling parameter (e.g., the slot offset K1). When the implicit scheduling parameter indicates a second value (e.g., K1=1), processor 1112 may be configured to determine that the time domain resource allocation starts before the end of the PDSCH in the same slot (e.g., slot n) or in the next slot (e.g., slot n+1). Processor 1112 may be able to perform the uplink transmission on the allocated time domain resources.

In some implementations, processor 1112 may receive, via transceiver 1116, the PDCCH comprising the downlink assignment (e.g., PDSCH) and the PUCCH resource indicator. After receiving the PUCCH resource indicator, processor 1112 may be configured to determine the value of the scheduling parameter (e.g., the slot offset K1). When the implicit scheduling parameter indicates a first value (e.g., K1=0), processor 1112 may be configured to determine that the time domain resource allocation starts after the PDSCH combined with a processing time (e.g., N1). Processor 1112 may be able to perform the uplink transmission on the allocated time domain resources.

In some implementations, processor 1112 may receive, via transceiver 1116, the PDCCH comprising the downlink assignment (e.g., PDSCH) and the PUCCH resource indicator. After receiving the PUCCH resource indicator, processor 1112 may be configured to determine the value of the scheduling parameter (e.g., the slot offset K1). When the implicit scheduling parameter indicates a second value (e.g., K1=1), processor 1112 may be configured to determine that the time domain resource allocation starts before the end of the PDSCH combined with a processing time (e.g., N1) in the same slot (e.g., slot n) or in the next slot (e.g., slot n+1). Processor 1112 may be able to perform the uplink transmission on the allocated time domain resources.

In some implementations, processor 1112 may be configured to determine the PUSCH mapping type according to the implicit scheduling parameter. The implicit scheduling parameter may comprise the symbol index indicated for the PUSCH. In an event that the time domain resource allocation for the PUSCH indicates a first symbol index (e.g., symbol index 0) in the slot (e.g., first symbol in the slot) as the starting symbol, processor 1112 may be configured to determinehat the PUSCH mapping type is a first type (e.g., type A). In an event that the time domain resource allocation for the PUSCH indicates a second symbol index (e.g., symbol index 1-13) in the slot (e.g., the symbols in the slot apart from the first symbol) as the starting symbol, processor 1112 may be configured to determinehat the PUSCH mapping type is a second type (e.g., type B). Processor 1112 may be able to perform the uplink transmission according to the determined PUSCH mapping type.

In some implementations, the implicit scheduling parameter may comprise the symbol index indicated for the PDSCH. In an event that the time domain resource allocation for the PDSCH indicates a first symbol index in the slot (e.g., one of the first X symbols I in the slot) as the starting symbol, processor 1112 may be configured to determinehat the PUSCH mapping type is a first type (e.g., type A). In an event that the time domain resource allocation for the PUSCH indicates a second symbol index in the slot (e.g., one of the last 14-X symbols in the slot) as the starting symbol, processor 1112 may be configured to determinehat the PUSCH mapping type is a second type (e.g., type B). For example and without limitation, the X may be equal to 4. Processor 1112 may be able to perform the uplink transmission according to the determined PUSCH mapping type.

In some implementations, processor 1122 may configure processor 1112 with a table for the time domain resource allocation for PUSCH and/or PDSCH. Processor 1112 may be configured to determine a starting time of the time domain resource allocation according to the table.

### Illustrative Processes

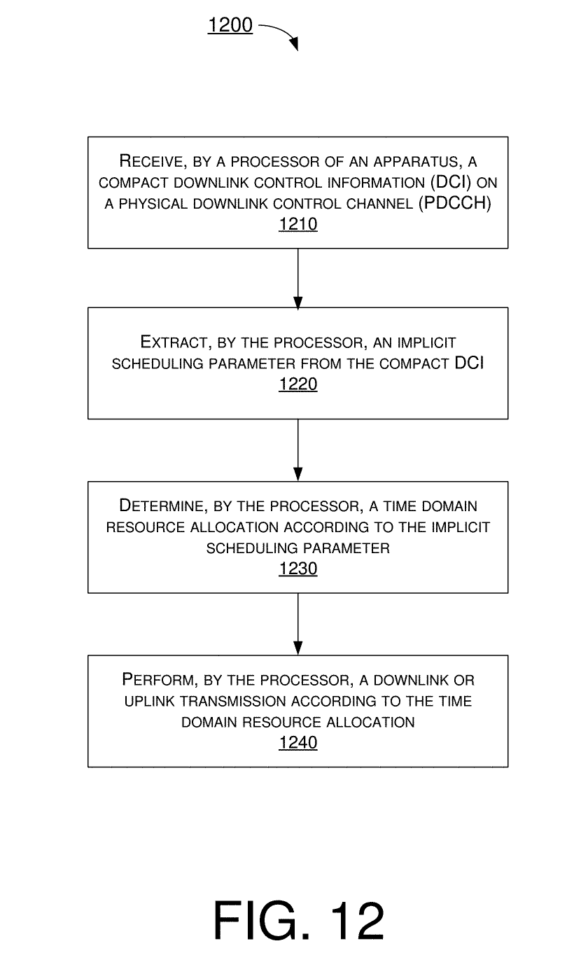

FIG. 12 illustrates an example process 1200 in accordance with an implementation of the present disclosure. Process 1200 may be an example implementation of above scenarios, whether partially or completely, with respect to time domain resource allocation for compact DCI design and operations with the present disclosure. Process 1200 may represent an aspect of implementation of features of communication apparatus 1110. Process 1200 may include one or more operations, actions, or functions as illustrated by one or more of blocks 1210, 1220, 1230 and 1240. Although illustrated as discrete blocks, various blocks of process 1200 may be divided into additional blocks, combined into fewer blocks, or eliminated, depending on the desired implementation. Moreover, the blocks of process 1200 may executed in the order shown in FIG. 12 or, alternatively, in a different order. Process 1200 may be implemented by communication apparatus 1110 or any suitable UE or machine type devices. Solely for illustrative purposes and without limitation, process 1200 is described below in the context of communication apparatus 1110. Process 1200 may begin at block 1210.

At 1210, process 1200 may involve processor 1112 of apparatus 1110 receiving a compact DCI on a PDCCH. Process 1200 may proceed from 1210 to 1220.

At 1220, process 1200 may involve processor 1112 extracting an implicit scheduling parameter from the compact DCI. Process 1200 may proceed from 1220 to 1230.

At 1230, process 1200 may involve processor 1112 determining a time domain resource allocation according to the implicit scheduling parameter. Process 1200 may proceed from 1230 to 1240.

At 1240, process 1200 may involve processor 1112 performing a downlink or uplink transmission according to the time domain resource allocation.

In some implementations, the implicit scheduling parameter may comprise at least one of a slot offset K0, a slot offset K1, a slot offset K2, a mapping type, and a table.

In some implementations, the implicit scheduling parameter may comprise only one bit.

In some implementations, process 1200 may involve processor 1112 determining that the time domain resource allocation starts after the PDCCH when the implicit scheduling parameter indicates a first value. Alternatively, process 1200 may involve processor 1112 determining that the time domain resource allocation starts before end of the PDCCH when the implicit scheduling parameter indicates a second value.

In some implementations, process 1200 may involve processor 1112 determining that the time domain resource allocation starts after the PDCCH combined with a processing time when the implicit scheduling parameter indicates a first value. Alternatively, process 1200 may involve processor 1112 determining that the time domain resource allocation starts before end of the PDCCH combined with a processing time when the implicit scheduling parameter indicates a second value.

In some implementations, process 1200 may involve processor 1112 determining that the time domain resource allocation starts with the PDCCH when the implicit scheduling parameter indicates a first value. Alternatively, process 1200 may involve processor 1112 determining that the time domain resource allocation starts before the PDCCH when the implicit scheduling parameter indicates a second value.

In some implementations, process 1200 may involve processor 1112 determining that the time domain resource allocation starts after a PDSCH when the implicit scheduling parameter indicates a first value. Alternatively, process 1200 may involve processor 1112 determining that the time domain resource allocation starts before end of a PDSCH when the implicit scheduling parameter indicates a second value.

In some implementations, process 1200 may involve processor 1112 determining that the time domain resource allocation starts after a PDSCH combined with a processing time when the implicit scheduling parameter indicates a first value. Alternatively, process 1200 may involve processor 1112 determining that the time domain resource allocation starts before end of a PDSCH combined with a processing time when the implicit scheduling parameter indicates a second value.

In some implementations, process 1200 may involve processor 1112 determining that a PUSCH/PDSCH mapping type is a first type when the implicit scheduling parameter indicates a first symbol index. Alternatively, process 1200 may involve processor 1112 determining that a PUSCH/PDSCH mapping type is a second type when the implicit scheduling parameter indicates a second symbol index.

In some implementations, process 1200 may involve processor 1112 determining a starting time of the time domain resource allocation according to a table.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a compact downlink control information (DCI) on a physical downlink control channel (PDCCH);
extracting, by the processor, an implicit scheduling parameter from the compact DCI;
determining, by the processor, a time domain resource allocation according to the implicit scheduling parameter; and
performing, by the processor, a downlink or uplink transmission according to the time domain resource allocation.

2. The method of claim 1, wherein the implicit scheduling parameter comprises at least one of a slot offset K0, a slot offset K1, a slot offset K2, a mapping type, and a table.

3. The method of claim 1, wherein the implicit scheduling parameter comprises one bit.

4. The method of claim 1, wherein the determining comprises:
determining that the time domain resource allocation starts after the PDCCH when the implicit scheduling parameter indicates a first value; or
determining that the time domain resource allocation starts before end of the PDCCH when the implicit scheduling parameter indicates a second value.

5. The method of claim 1, wherein the determining comprises:
determining that the time domain resource allocation starts after the PDCCH combined with a processing time when the implicit scheduling parameter indicates a first value; or
determining that the time domain resource allocation starts before end of the PDCCH combined with a processing time when the implicit scheduling parameter indicates a second value.

6. The method of claim 1, wherein the determining comprises:
determining that the time domain resource allocation starts with the PDCCH when the implicit scheduling parameter indicates a first value; or
determining that the time domain resource allocation starts before the PDCCH when the implicit scheduling parameter indicates a second value.

7. The method of claim 1, wherein the determining comprises:
determining that the time domain resource allocation starts after a physical downlink shared channel (PDSCH) when the implicit scheduling parameter indicates a first value; or
determining that the time domain resource allocation starts before end of a physical downlink shared channel (PDSCH) when the implicit scheduling parameter indicates a second value.

8. The method of claim 1, wherein the determining comprises:
determining that the time domain resource allocation starts after a physical downlink shared channel (PDSCH) combined with a processing time when the implicit scheduling parameter indicates a first value; or
determining that the time domain resource allocation starts before end of a physical downlink shared channel (PDSCH) combined with a processing time when the implicit scheduling parameter indicates a second value.

9. The method of claim 1, wherein the determining comprises:
determining that a physical uplink shared channel (PUSCH)/physical downlink shared channel (PDSCH) mapping type is a first type when the implicit scheduling parameter indicates a first symbol index; or
determining that a physical uplink shared channel (PUSCH)/physical downlink shared channel (PDSCH) mapping type is a second type when the implicit scheduling parameter indicates a second symbol index.

10. The method of claim 1, wherein the determining comprises determining a starting time of the time domain resource allocation according to a table.

11. An apparatus, comprising:
a transceiver capable of wirelessly communicating with a network node of a wireless network; and
a processor communicatively coupled to the transceiver, the processor capable of:
receiving, via the transceiver, a compact downlink control information (DCI) on a physical downlink control channel (PDCCH);
extracting an implicit scheduling parameter from the compact DCI;
determining a time domain resource allocation according to the implicit scheduling parameter; and
performing, via the transceiver, a downlink or uplink transmission according to the time domain resource allocation.

12. The apparatus of claim 11, wherein the implicit scheduling parameter comprises at least one of a slot offset K0, a slot offset K1, a slot offset K2, a mapping type, and a table.

13. The apparatus of claim 11, wherein the implicit scheduling parameter comprises one bit.

14. The apparatus of claim 11, wherein, in determining the time domain resource allocation according to the implicit scheduling parameter, the processor is capable of:
determining that the time domain resource allocation starts after the PDCCH when the implicit scheduling parameter indicates a first value; or
determining that the time domain resource allocation starts before end of the PDCCH when the implicit scheduling parameter indicates a second value.

15. The apparatus of claim 11, wherein, in determining the time domain resource allocation according to the implicit scheduling parameter, the processor is capable of:
determining that the time domain resource allocation starts after the PDCCH combined with a processing time when the implicit scheduling parameter indicates a first value; or
determining that the time domain resource allocation starts before end of the PDCCH combined with a processing time when the implicit scheduling parameter indicates a second value.

16. The apparatus of claim 11, wherein, in determining the time domain resource allocation according to the implicit scheduling parameter, the processor is capable of:
determining that the time domain resource allocation starts with the PDCCH when the implicit scheduling parameter indicates a first value; or
determining that the time domain resource allocation starts before the PDCCH when the implicit scheduling parameter indicates a second value.

17. The apparatus of claim 11, wherein, in determining the time domain resource allocation according to the implicit scheduling parameter, the processor is capable of:
determining that the time domain resource allocation starts after a physical downlink shared channel (PDSCH) when the implicit scheduling parameter indicates a first value; or
determining that the time domain resource allocation starts before end of a physical downlink shared channel (PDSCH) when the implicit scheduling parameter indicates a second value.

18. The apparatus of claim 11, wherein, in determining the time domain resource allocation according to the implicit scheduling parameter, the processor is capable of:
determining that the time domain resource allocation starts after a physical downlink shared channel (PDSCH) combined with a processing time when the implicit scheduling parameter indicates a first value; or
determining that the time domain resource allocation starts before end of a physical downlink shared channel (PDSCH) combined with a processing time when the implicit scheduling parameter indicates a second value.

19. The apparatus of claim 11, wherein, in determining the time domain resource allocation according to the implicit scheduling parameter, the processor is capable of:
determining that a physical uplink shared channel (PUSCH)/physical downlink shared channel (PDSCH) mapping type is a first type when the implicit scheduling parameter indicates a first symbol index; or
determining that a physical uplink shared channel (PUSCH)/physical downlink shared channel (PDSCH) mapping type is a second type when the implicit scheduling parameter indicates a second symbol index.

20. The apparatus of claim 11, wherein, in determining the time domain resource allocation according to the implicit scheduling parameter, the processor is capable of determining a starting time of the time domain resource allocation according to a table.
